(19) United States
(12) Patent Application Publication
(10) Pub. No.: US 2025/0287081 A1
(43) Pub. Date: Sep. 11, 2025

(54) HYPERSPECTRAL SENSOR WITH DIFFRACTIVE FOCUSING PIXEL AND NEURAL NETWORK SPECTRAL RECOVERY

(71) Applicant: SONY SEMICONDUCTOR SOLUTIONS CORPORATION, Kanagawa (JP)

(72) Inventors: Victor A. Lenchenkov, Victor, NY (US); Frederick T. Brady, Rochester, NY (US); Tejaswini Ananthanarayana, Rochester, NY (US); Gui Gui, Rochester, NY (US); Trevor O'Loughlin, Rochester, NY (US)

(73) Assignee: SONY SEMICONDUCTOR SOLUTIONS CORPORATION, Kanagawa (JP)

(21) Appl. No.: 18/601,553

(22) Filed: Mar. 11, 2024

(51) Int. Cl. H04N 23/12; G06T 7/90; H04N 23/55

(52) U.S. Cl. CPC H04N 23/12; G06T 7/90; H04N 23/55; G06T 2207/20084

(57) ABSTRACT

Methods, sensors, and systems for determining a spectral band of light incident on one or more pixels are provided. Each pixel includes a set of sub-pixels. Light incident on an area of the pixel is diffracted by a set of diffraction elements, producing a diffraction pattern across the sub-pixels. Outputs from the sub-pixels are provided to application programming executed by a processor to produce an output that includes an indication of one of a plurality of spectral bands that the light incent on the pixel belongs. The application programming can implement a neural network that has been trained to assign the light incident on an area of a pixel to one spectral band in the plurality of spectral bands. The number of spectral bands to which light incident on the pixel can be assigned can be greater than the number of sub-pixels included in the pixel.

### FIELD

The present disclosure relates to imaging methods and devices incorporating a diffractive focusing pixel and using a trained neural network for spectral recovery.

### BACKGROUND

Digital image sensors are commonly used in a variety of electronic devices, such as handheld cameras, security systems, telephones, computers, and tablets, to capture images. In a typical arrangement, light sensitive areas or pixels are arranged in a two-dimensional array having multiple rows and columns of pixels. Each pixel generates an electrical charge in response to receiving photons as a result of being exposed to incident light. For example, each pixel can include a photodiode that generates charge in an amount that is generally proportional to the amount of light (i.e. the number of photons) incident on the pixel during an exposure period. The charge can then be read out from each of the pixels, for example through peripheral circuitry.

In conventional color image sensors, absorptive color filters are used to enable the image sensor to detect the color of incident light. The color filters are typically disposed in sets (e.g. of red, green, and blue (RGB); cyan, magenta, and yellow (CMY); or red, green, blue, and infrared (RGBIR)). Such arrangements have about 3-4 times lower sensitivity and signal to noise ratio (SNR) at low light conditions, color crosstalk, color shading at high chief ray angles (CRA), and lower spatial resolution due to color filter patterning, resulting in lower spatial frequency as compared to monochrome sensors (i.e. as compared to sensors without color filters). However, the image information provided by a monochrome sensor does not include information about the color or wavelength of the imaged object. The relatively low sensitivity and spatial resolution of filter based systems is particularly apparent where wavelength sensitivity over a hyperspectral range is required.

Image sensors have been developed that utilize uniform, non-focusing metal gratings, to diffract light in a wavelength dependent manner, before that light is absorbed in a silicon substrate. Such an approach enables the wavelength characteristics (i.e. the color) of incident light to be determined, without requiring the use of absorptive filters. However, the non-focusing diffractive grating results in light loss before the light reaches the substrate. Such an approach also requires an adjustment or shift in the microlens and the grating position and structures across the image plane to accommodate high chief ray angles (CRAs).

Other sensor systems that enable color to be sensed without the use of color filters are so called “color routers”, which direct light among a 2×2 Bayer array of red, green, green, and blue pixels. In such systems, instead of using absorptive filters to select the light that is incident on the individual pixels, the light is routed to the pixels within the Bayer array on the basis of color by high index of refraction diffractive elements. Although this avoids the loss inherent to absorptive filter designs, the resulting color resolution of the sensor is the same as or similar to that of a filter based Bayer array. In addition, determining the pattern of the diffractive elements used to route the light of different colors requires the use of complex design procedures, and results in a relatively tall structure.

Still other sensor systems incorporate diffractive scattering elements disposed over pixels that each incorporate a plurality of sub-pixels. In such sensors, the diffractive scattering elements are included in a diffraction layer disposed adjacent a light incident surface side of the pixels. Color information regarding light incident on a pixel is determined by comparing ratios of signals between pairs of sub-pixels to a calibration table containing ratios of signals determined using incident light at a number of different, known wavelengths. A wavelength with signal ratios that result in a smallest difference as compared to the observed set of signal ratios is assigned as the color of the light incident on the pixel. Alternatively, analytic techniques can be used to calculate the wavelength of light incident on a pixel from the ratios of the signals output by the included sub-pixels. However, the wavelength resolution of such systems is limited by the number of sub-pixels in each pixel. For example, when applying an analytic method, the number of wavelength bands that can be resolved is limited to the number of sub-pixels in a given pixel. Moreover, simply increasing the number of sub-pixels in a pixel to increase wavelength resolution results in decreased image resolution, due to limitations in the ability to make the sub-pixels small enough for use with a desirably small image spot size. In particular, providing a large enough image spot size to cover a large number of sub-pixels within a pixel requires defocusing the imaging lens.

Accordingly, it would be desirable to provide an image sensor with high sensitivity and high spectral resolution that could be produced more easily than previous devices.

### SUMMARY

Embodiments of the present disclosure provide image sensing methods, image sensors, and image sensing systems that provide high spectral resolution and sensitivity. An image sensor in accordance with embodiments of the present disclosure includes a sensor array having a plurality of pixels. Each pixel in the plurality of pixels includes a plurality of sub-pixels or photoelectric conversion elements formed within a sensor substrate. In addition, each pixel is associated with a set of diffraction features. An output from the sub-pixels is provided to a processor running application programming that produces an output in the form of a determined spectral band of light incident on a given pixel. In accordance with embodiments of the present disclosure, the number of possible spectral bands is greater than the number of sub-pixels in the given pixel. In accordance with the least some embodiments of the present disclosure, the application programming implements a neural network that is trained to categorize light incident on a pixel as belonging to one of a plurality of spectral bands based on outputs from the sub-pixels included in that pixel.

A sensor system incorporating an image sensor in accordance with embodiments of the present disclosure generally includes imaging optics that focuses light collected from a scene onto the image sensor. The image sensor can include a plurality of pixels disposed in an array. Each pixel in the array includes a plurality of sub-pixels. As an example, but without limitation, each sub-pixel can include a light sensitive area, such as a photodiode or other photoelectric conversion element, disposed on or in a substrate. A diffraction layer is disposed over a light incident surface side of the substrate and in particular over the sub-pixels. The diffraction layer includes a plurality of groups of diffraction elements or features. Each pixel can be associated with one group of diffraction elements. In accordance with embodiments of the present disclosure, the diffraction elements associated with a given pixel can operate to focus and diffract the collected light onto the sub-pixels of that pixel. A diffraction pattern produced by a set diffraction elements over an area of the associated pixel is dependent on the wavelength of light incident thereon. Accordingly, differences in the relative strengths of output signals produced by the sub-pixels of a pixel are different for different wavelengths of incident light, and can be used to determine a spectral band to which the incident light belongs. The sensor system also includes a processor and data storage. The processor and data storage can operate to execute application programming that analyzes the output signals from the sub-pixels of a pixel to determine a spectral band of light incident on the pixel. In accordance with at least some embodiments of the present disclosure, the application programming implements a neural network that has been trained to assign light incident of the sub-pixels of the pixels to one of a plurality of spectral bands. Moreover, by determining the spectral band of light incident on each pixel in the image sensor, image information that includes wavelength information regarding the incident light can be output.

A process in accordance with embodiments of the present disclosure can include providing an image sensor system having an image sensor that includes a plurality of pixels disposed in an array. Each pixel includes a plurality of sub-pixels disposed across an area of the pixel. The process can additionally include focusing light gathered from an object space onto a surface of the image sensor. According to the process, the incident light is passed through a diffraction layer disposed over a light incident surface side of the image sensor. The diffraction layer includes sets of diffraction elements, with one set of diffraction elements for each pixel in the plurality of pixels. The sets of diffraction elements produce different diffraction patterns across an area of an associated pixel for different wavelengths of incident light. As a result, the relative outputs of the sub-pixels of a pixel are different for different wavelengths of incident light. The process thus includes collecting the output signals from the sub-pixels within the pixels. Relative differences or ratios between the output signals of the sub-pixels within a given pixel are then analyzed to determine a spectral or wavelength band of the light incident on that pixel. In accordance with further embodiments of the present disclosure, the process includes providing the outputs of the sub-pixels of a given pixel to a neural network that has been trained to associate different ratios or patterns of outputs amongst those sub-pixels with different wavelengths of incident light. The neural network can then assign a spectral band to the incident light. An output that includes an indication of the wavelength of light incident on pixels included in the image sensor can thus be produced and provided as an output. In accordance with still further embodiments of the present disclosure, an image can be output, with colors or pseudo-colors assigned to areas of the image corresponding to the individual pixels based on the determinations of the application programming. Alternatively or in addition, an output can include a numeric value or range indicating the determined wavelength of the incident light. Moreover, in accordance with embodiments of the present disclosure, the number of spectral bands into which light incident on a pixel can be assigned can be greater than the number of sub-pixels included in that pixel. Accordingly, the process enables an image sensor having high sensitivity, high spatial resolution, high spectral resolution, wide spectral range, and a low stack height. In addition, an image sensor in accordance with embodiments of the present disclosure can be manufactured using conventional CMOS processes.

Additional features and advantages of embodiments of the present disclosure will become more readily apparent from the following description, particularly when considered together with the accompanying drawings.

### BRIEF DESCRIPTION OF THE DRAWINGS

FIG. 1 depicts elements of a hyperspectral sensor in accordance with embodiments of the present disclosure;

FIG. 2 is a plan view of a portion of an exemplary sensor in accordance with the prior art;

FIG. 3 is a cross section of a portion of an exemplary sensor in accordance with the prior art;

FIG. 4 is a graph depicting the sensitivity of an exemplary hyperspectral sensor in accordance with the prior art and a hyperspectral sensor in accordance with embodiments of the present disclosure to light of different wavelengths;

FIG. 5 depicts components of a system incorporating a hyperspectral sensor in accordance with embodiments of the present disclosure;

FIG. 6 is a perspective view of a pixel included in a hyperspectral sensor in accordance with embodiments of the present disclosure;

FIG. 7 is a top plan view of a light incident surface of a pixel included in a hyperspectral sensor in accordance with embodiments of the present disclosure;

FIG. 8 is a cross-section in elevation of a pixel included in a hyperspectral sensor in accordance with embodiments of the present disclosure;

FIG. 9 is a perspective view of a pixel included in a hyperspectral sensor in accordance with embodiments of the present disclosure and depicts the diffraction of incident light by diffraction elements associated with the pixel;

FIG. 10 depicts distributions of light of different wavelengths across the sub-pixels of a pixel included in a hyperspectral image sensor in accordance with embodiments of the present disclosure;

FIG. 11 depicts the response of sub-pixels of a pixel included in a hyperspectral image sensor in accordance with embodiments of the present disclosure to light of different wavelengths;

FIG. 12 is a top plan view of a portion of a hyperspectral image sensor in accordance with embodiments of the present disclosure;

FIG. 13 is a block diagram of a processing system that can be included in a system in accordance with embodiments of the present disclosure;

FIG. 14 is a flowchart depicting aspects of a method for training a neural network in accordance with embodiments of the present disclosure;

FIG. 15 is a flowchart depicting aspects of a process for reconstructing an image received at the hyperspectral pixels of an imaging system in accordance with embodiments of the present disclosure;

FIG. 16 is a block diagram illustrating a schematic configuration example of a camera that is an example of an image sensor in accordance with embodiments of the present disclosure; and

FIG. 17 is a top plan view of a hyperspectral image sensor in accordance with embodiments of the present disclosure.

### DETAILED DESCRIPTION

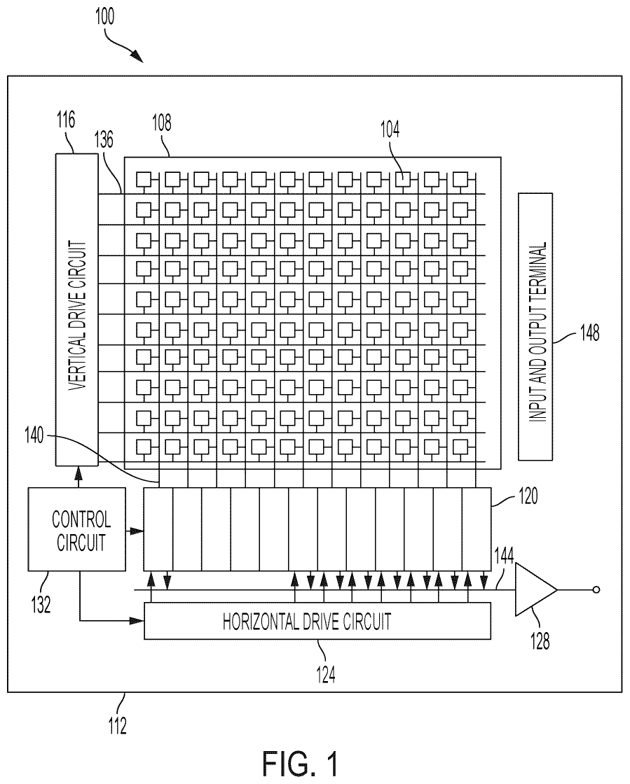

FIG. 1 is a diagram that depicts elements of a hyperspectral image sensor or device 100 in accordance with embodiments of the present disclosure. In general, the hyperspectral image sensor 100 includes a plurality of hyperspectral pixels 104 disposed in an array 108. More particularly, the hyperspectral pixels 104 can be disposed within an array 108 having a plurality of rows and columns of hyperspectral pixels 104. Moreover, the hyperspectral pixels 104 are formed on or in a sensor substrate 112. In addition, one or more peripheral or other circuits can be formed in connection with the sensor substrate 112. Examples of such circuits include a vertical drive circuit 116, a column signal processing circuit 120, a horizontal drive circuit 124, an output circuit 128, and a control circuit 132. As described in greater detail elsewhere herein, each of the hyperspectral pixels 104 within a hyperspectral image sensor 100 in accordance with embodiments of the present disclosure includes a plurality of photosensitive sites or photoelectric conversion elements, referred to herein as sub-pixels.

The vertical drive circuit 116 can, for example, be configured with a shift register, can operate to select a pixel drive wiring 136, and can supply pulses for driving sub-pixels of hyperspectral pixels 104 through the selected drive wiring 136 in units of a row. The vertical drive circuit 116 can also selectively and sequentially scan elements of the array 108 in units of a row in a vertical direction, and supply the signals generated within the hyperspectral pixels 104 according to an amount of light they have received to the column signal processing circuit 120 through a vertical signal line 140.

The column signal processing circuit 120 can operate to perform signal processing, such as noise removal, on the signals output from the hyperspectral pixels 104. For example, the column signal processing circuit 120 can perform signal processing, such as correlated double sampling (CDS), to remove a specific fixed patterned noise of a selected hyperspectral pixel 104 and an analog to digital (A/D) conversion of the signal.

The horizontal drive circuit 124 can include a shift register. The horizontal drive circuit 124 can select each column signal processing circuit 120 in order by sequentially outputting horizontal scanning pulses, causing each column signal processing circuit 120 to output a pixel signal to a horizontal signal line 144.

The output circuit 128 can perform predetermined signal processing with respect to the signals sequentially supplied from each column signal processing circuit 120 through the horizontal signal line 144. For example, the output circuit 128 can perform a buffering, black level adjustment, column variation correction, various digital signal processing, and other signal processing procedures. An input and output terminal 148 exchanges signals between the image sensor 100 and external components or systems.

The control circuit 132 can receive data for instructing an input clock, an operation mode, and the like, and can output data such as internal information related to the image sensor 100. Accordingly, the control circuit 132 can generate a clock signal that provides a standard for operation of the vertical drive circuit 116, the column signal processing circuit 120, and the horizontal drive circuit 124, and control signals based on a vertical synchronization signal, a horizontal synchronization signal, and a master clock. The control circuit 132 outputs the generated clock signal in the control signals to the various other circuits and components.

Accordingly, at least portions of a hyperspectral image sensor 100 in accordance with at least some embodiments of the present disclosure can be configured as a CMOS image sensor of a column A/D type in which column signal processing is performed.

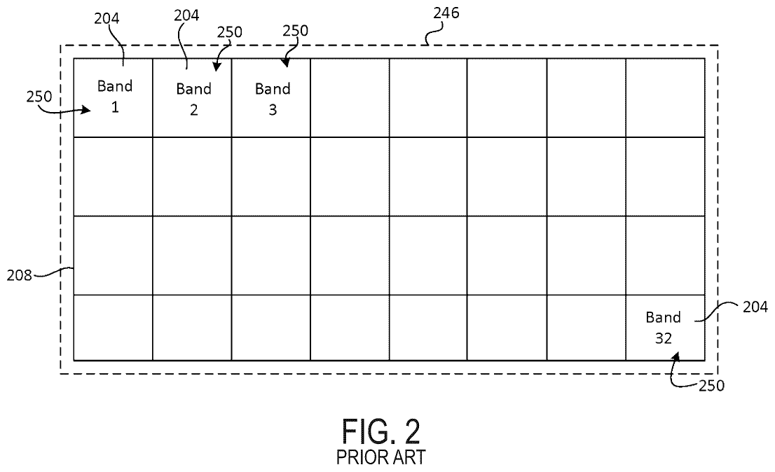

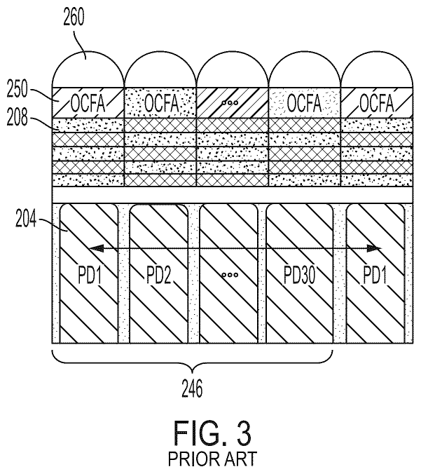

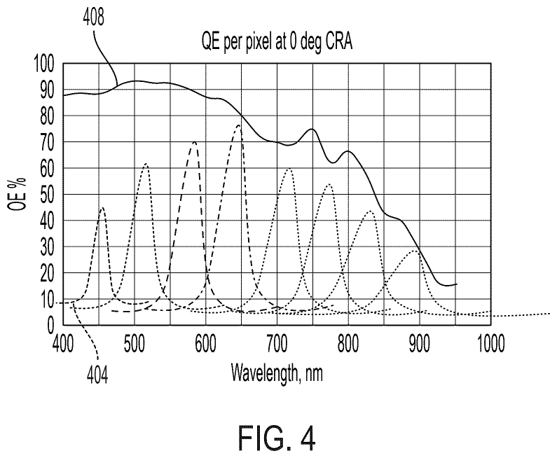

With reference now to FIGS. 2 and 3, portions of a pixel array 208 of an exemplary color sensing image sensor in accordance with the prior art are depicted. FIG. 2 shows a portion of the pixel array 208 in a plan view, and illustrates how individual pixels 204 are disposed in sets 246 of pixels 204 that together operate to provide wavelength detection over a hyperspectral range of wavelengths. In this particular example, each set 246 includes thirty-two pixels 204 disposed in a 4×8 sub-array. As can be appreciated by one of skill in the art, each set can include pixels with different filters that can each pass light within a different range wavelength of wavelengths, depending on the number and width of colors or spectral bands that the associated sensor is intended to detect. As can also be appreciated by one of skill in the art, as the wavelength selectivity of the filters 250 is increased, the sensitivity of the associated pixels is decreased. In addition, as the number of spectral bands that can be detected using the filters 250 is increased, the spatial resolution of the prior art image sensor is decreased. FIG. 3 depicts the pixel array 208 of the exemplary prior art image sensor in a partial cross-section taken in elevation. As shown, the conventional image sensor includes micro lenses 260 that function to focus light onto an associated pixel 204. In such a configuration, each individual pixel 204 is only sensitive to a relatively narrow portion of the spectrum. As a result, the spatial resolution of the image sensor is reduced as compared to monochrome sensors. Moreover, because the light incident on the photosensitive portion of each pixel 204 is filtered, sensitivity is lost. This is illustrated in FIG. 4, which includes lines 404 depicting the sensitivity of eight different pixels 204, each of which is associated with a filter capable of passing light within a different range of wavelengths. For comparison, the sensitivity of a hyperspectral diffractive focusing pixel as disclosed herein is shown at line 408. In addition to the various performance issues, conventional color and monochrome image sensors have a relatively high stack height, creating high spectral error for angled light. Moreover, such prior pixel arrays are relatively complex to manufacture.

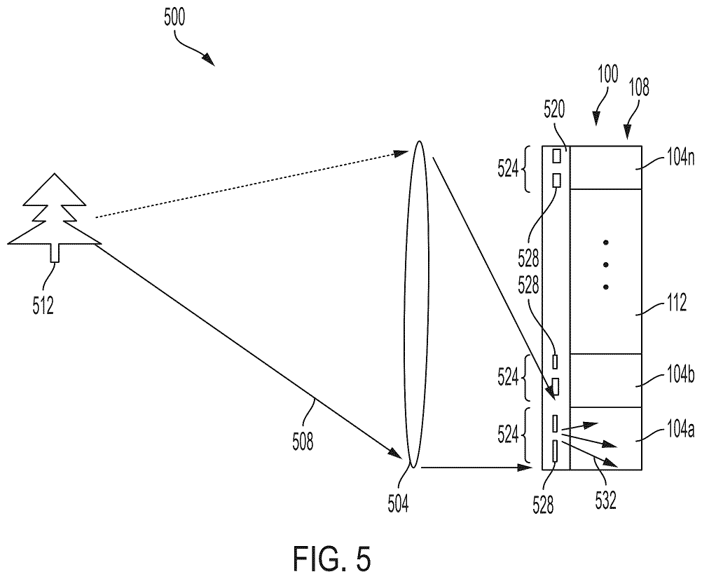

FIG. 5 depicts components of a system 500 incorporating a hyperspectral image sensor 100 in accordance with embodiments of the present disclosure, including a cross sectional view of elements of the pixel array 108 of the hyperspectral image sensor 100. As shown, the system 500 can include an optical system 504 that collects and focuses light from within a field of view of the system 500, including light 508 reflected or otherwise received from an object 512 within the field of view of the system 500, onto hyperspectral pixels 104 included in the pixel array 108 of the hyperspectral image sensor 100, hereinafter referred to as incident light 508. As can be appreciated by one of skill in the art after consideration of the present disclosure, the optical system 504 can include a number of lenses, mirrors, apertures, shutters, filters or other elements. In accordance with embodiments of the present disclosure, the pixel array 108 includes an imaging or sensor substrate 112 in which the hyperspectral pixels 104 of the array 108 are formed. In addition, the hyperspectral image sensor 100 includes a diffraction layer 520 in which a plurality of sets of diffraction features or elements 524 are disposed, with one set of diffraction features 524 provided for each hyperspectral pixel 104 within the array 108. Each set of diffraction elements includes a plurality of diffraction elements 528. As discussed in greater detail elsewhere herein, diffracted light 532 is produced by the diffraction elements 528 and is passed to the sub-pixels of the hyperspectral pixels 104 included in the array when incident light 508 is received at the pixel array 108.

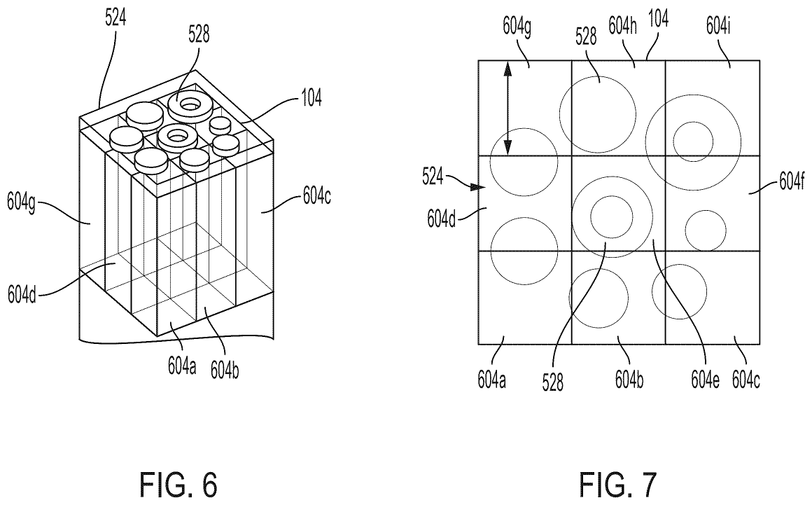

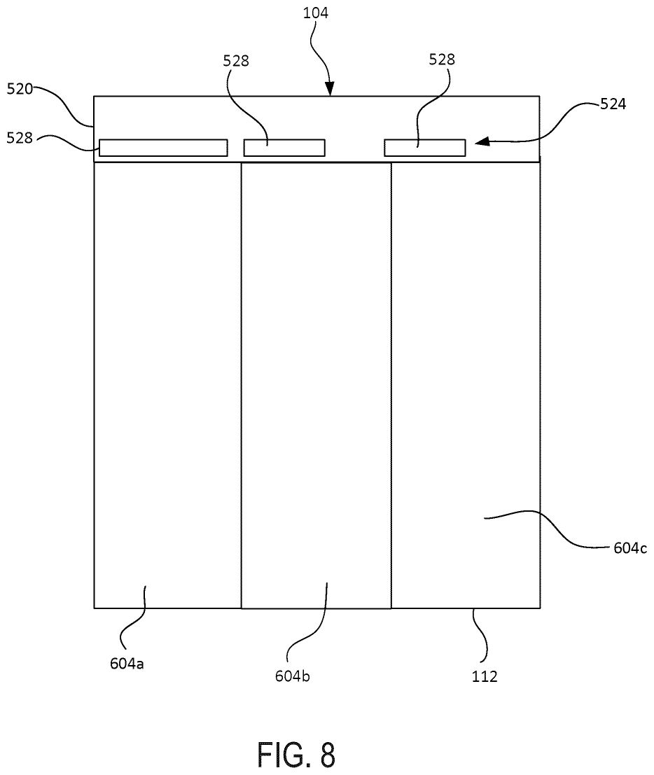

FIGS. 6, 7, and 8 are perspective, top, and cross section in elevation views respectively of a hyperspectral pixel 104 included in a hyperspectral image sensor 100 in accordance with embodiments of the present disclosure. As shown, each hyperspectral pixel 104 within the array 108 includes a plurality of sub-pixels 604. The sub-pixels 604 within a hyperspectral pixel 104 can be formed as adjacent photoelectric conversion elements or areas within the image sensor substrate 112. In operation, each sub-pixel 604 generates a signal in proportion to an amount of light 508 incident thereon. As an example, each sub-pixel 604 is a separate photodiode. As represented in FIGS. 6 and 7, each hyperspectral pixel 104 can include nine sub-pixels 604a-i, with each of the sub-pixels 604 having an equally sized, square-shaped light incident surface. However, embodiments of the present disclosure are not limited to such a configuration, and can instead have any number of sub-pixels 604, with each of the sub-pixels 604 having the same or different shape, and/or the same or different size as other sub-pixels 604 within the hyperspectral pixel 104. In accordance with still other embodiments of the present disclosure, different hyperspectral pixels 104 can have different shapes, sizes, and configurations of included sub-pixels 604.

Each set of diffraction features 524 includes multiple diffraction elements 528 that can take various forms. As illustrated in FIGS. 6 and 7, the diffraction elements 528 can be configured as transparent disks and rings disposed in a single plane within the diffraction layer 520. Where, for example, the sub-pixels 604 have dimensions of 0.7×0.7 μm at a light incident surface of the sensor substrate 112, the diffraction elements 528 can be 200 nm thick, and can have an outer diameter of from 100 to 270 nm. In accordance with further embodiments of the present disclosure, a hyperspectral pixel 104 in accordance with embodiments of the present disclosure can include a set of diffraction features 524 with diffraction elements 528 disposed in a plurality of planes on a light incident side of the sensor substrate 112. Other distributions of diffraction elements 528 within a hyperspectral pixel 104 are also possible. For instance, a hyperspectral pixel 104 can have a set of diffraction features 524 that includes diffraction elements 528 disposed in one or more planes disposed in a diffraction layer 520, and a set of diffraction features 524 that includes diffraction elements 528 disposed in one or more planes in the sensor substrate 112 and adjacent to (e.g. within 350 nm of) the light incident surface of the sensor substrate 112. In addition or as an alternative to disks and rings, the diffraction elements 528 can be configured as linear elements each having a longitudinal extent that is disposed radially about a center point of an associated hyperspectral pixel 104. In accordance with further embodiments of the present disclosure the diffraction elements can include various numbers of some or all of lines, disks, cylinders, and/or other shapes.

In accordance with at least some embodiments of the present disclosure, each of the diffraction elements 528 is transparent, and has an index of refraction that is lower or higher than an index of refraction of the layer 520 or substrate 112 in which the diffraction element 528 is formed. As examples, where the diffraction layer 520 is SiO2 with a refractive index n of about 1.46, the diffraction elements 528 disposed therein can be formed from SiN, TiO2, HfO2, Ta2O5, or SiC with a refractive index n of from about 2 to about 2.6.

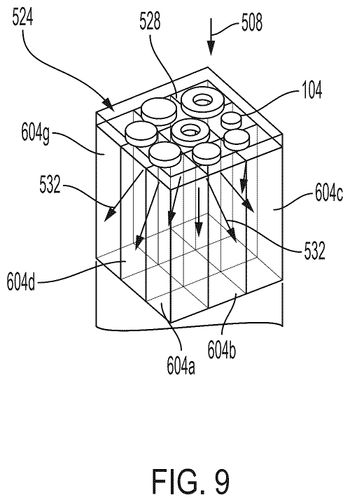

As previously noted, a set of diffraction features 524 is provided for each hyperspectral pixel 104. As depicted in FIG. 9, which is a perspective view of a hyperspectral pixel 104, the diffraction elements 528 in the set 524 act to diffract incident light 508. Moreover, because the interference pattern produced by the diffraction elements 528 strongly correlates with the wavelength of the incident light 508, the incident light 508 wavelength can be identified with very high specificity (e.g. within 25 nm or less). The diffracted light 532 falls or is incident on the sub-pixels 604 of the hyperspectral pixel 104.

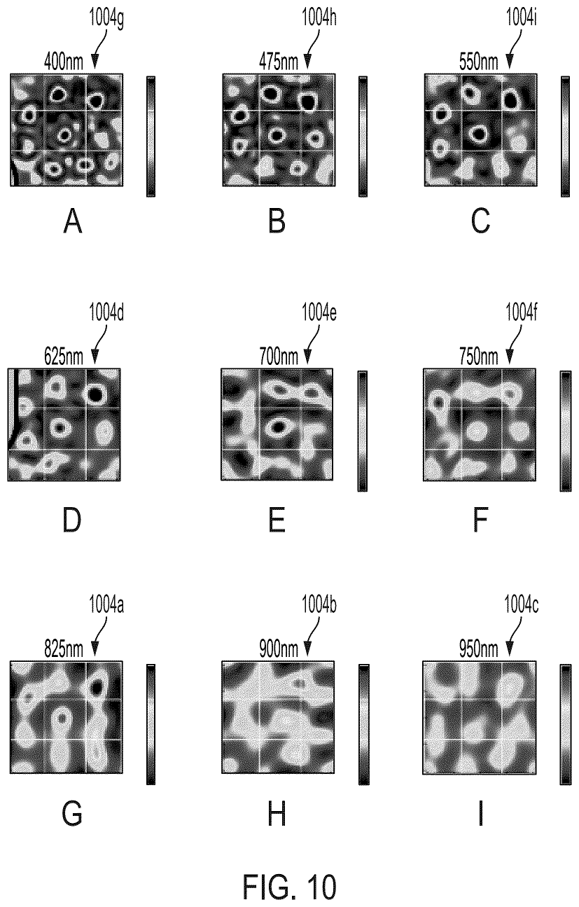

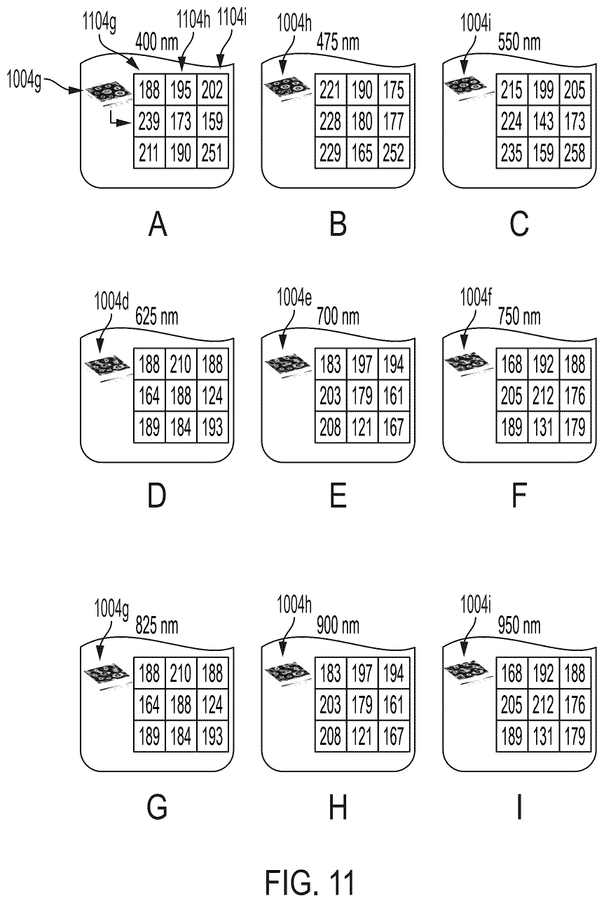

Accordingly, and as depicted in A-I of FIG. 10, the set of diffraction elements 524 associated with a hyperspectral pixel 104 will form different diffraction patterns 1004a-g across the corresponding sub-pixels 604a-g for different wavelengths of incident light 508. As depicted in A-I of FIG. 11, the different diffraction patterns 1004 result in different sub-pixel 604 responses 1104a-g at the sub-pixels 604a-g for different wavelengths of incident light 508, where the value of the response 1104 associated with each sub-pixel 604 represents a relative magnitude of the response. As the diffraction patterns 1004 at the different wavelengths are unique, the different sub-pixel 604 responses 1104 at the different wavelengths, and in particular the sub-pixel 604 responses relative to one another, can be used to assign incident light 508 to a specific spectral band. Moreover, as discussed in greater detail elsewhere herein, the number of spectral bands that can be recognized by a hyperspectral image sensor 100 incorporating one or more hyperspectral pixels 104 in accordance with embodiments of the present disclosure can be greater than the number of sub-pixels 604 included in each of the hyperspectral pixels 104.

In the example of FIG. 10, wavelength dependent diffraction patterns or fingerprints 1004 at nine different wavelengths of incident light 508 that are spaced apart from one another by 75 nm are depicted. However, embodiments of the present disclosure are capable of distinguishing between different wavelengths of incident light 508 that are spaced apart from one another by a narrower range of wavelengths. Moreover, embodiments of the present disclosure provide a hyperspectral image sensor 100 capable of distinguishing between a greater number of spectral bands than there are sub-pixels 604 in the hyperspectral pixels 104. As an example, but without limitation, embodiments of the present disclosure can provide a hyperspectral image sensor 100 including a hyperspectral pixel 104 having nine sub-pixels 604 in which different wavelengths of incident light can be determined as falling into one of 28 wavelength bands, each having a wavelength resolution of 20 nm over a range of wavelengths extending from 400 nm to 960 nm (i.e. incident light having a wavelength of from 400 nm to 980 nm can be classified as falling within a determined wavelength or spectral band within that range that is 20 nm wide).

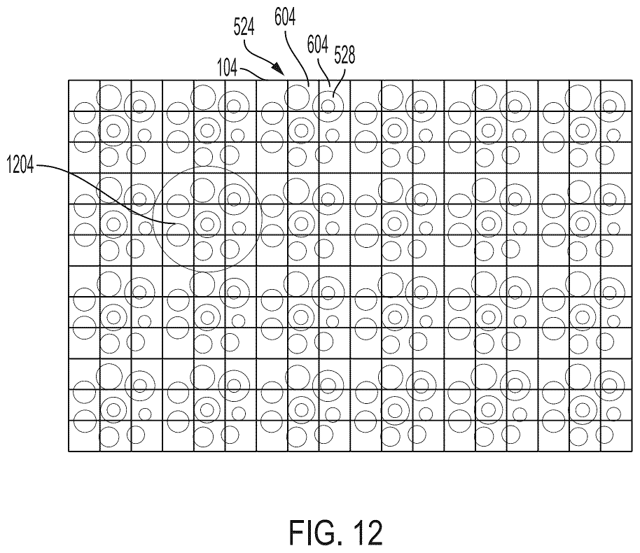

With reference now to FIG. 12, a portion of a light incident surface side of a two-dimensional array 108 of hyperspectral pixels 104 included in a hyperspectral image sensor 100 in accordance with embodiments of the present disclosure is depicted in plan view. Within the selected section, sets 524 of diffraction elements 528 can be repeated across the different hyperspectral pixels 104. In addition, an image spot 1204 formed on the light incident surface of the hyperspectral image sensor 100 by the imaging optics 504 is depicted. More particularly, the image spot 1204 illustrated in FIG. 12 depicts a minimal resolved spot size diameter for an ideal imaging lens or optics 504. As shown, the minimum diameter of the image spot 1204 is slightly larger than the width and height of the hyperspectral pixels 504. Numerically, the minimal resolved spot size diameter for an ideal imaging lens 504 is about equal to

2.44*F #*wavelength>hyperspectral pixel 104 size

where F # is the f value of the imaging optics 504, where wavelength is the wavelength of the incident light, and where the hyperspectral pixel 104 size is the greater of the width or height of the hyperspectral pixel 504 light incident surface.

As can be appreciated by one of skill in the art after consideration of the present disclosure, maintaining a relatively small image spot 1204 diameter is advantageous, because that in turn enables an image to be resolved by the hyperspectral image sensor 100 at a relatively high image resolution. However, because producing light sensitive sites or sub-pixels 604 having extremely small areas and acceptable sensitivity is difficult or impossible, the number of photosensitive sites that can be included within the area of an image spot 1204 is, as a practical matter, limited. Using previous analytic methods, the maximum number of spectral bands into which light incident on a set of sub-pixels within a hyperspectral pixel can be classified is equal to the number of sub-pixels 604 within that hyperspectral pixel 104. However, embodiments of the present disclosure enable the classification of light incident on a hyperspectral pixel 104 into a number of spectral bands that can be much larger (e.g. three times or more) than the number of sub-pixels 604 included in the hyperspectral pixel 104.

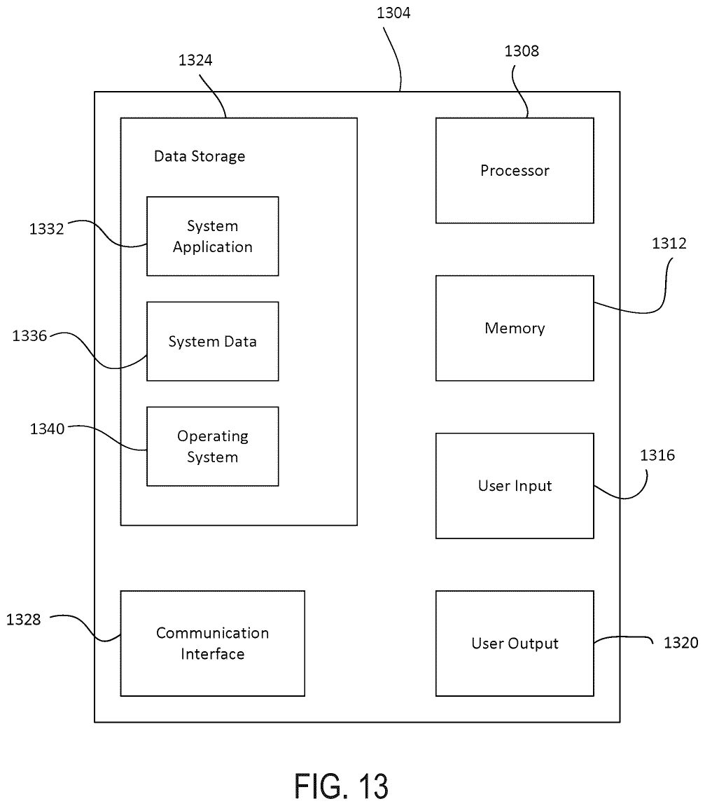

FIG. 13 is a block diagram depicting a processing system 1304 that can be associated with a hyperspectral image sensor 100 in accordance with embodiments of the present disclosure. As an example, but without limitation, the processing system 1304 can be provided as part of or in conjunction with a camera or other imaging system 500 incorporating a hyperspectral image sensor 100. In general, the processing system 1304 is provided with output signals from sub-pixels 604 included in hyperspectral pixels 104 of the image sensor 100 and assigns the light incident on each of the hyperspectral pixels 104 to a spectral band based on the received output signals. In addition, the processing system 1304 can perform functions related to operating the imaging system 500 incorporating the hyperspectral image sensor 100, such as operating an aperture and shutter associated with the imaging optics 504, focusing the imaging optics 504, and the like. The processing system 1304 generally includes a processor 1308 and memory 1312. In addition, the processing system 1304 can include one or more user input devices 1316 and one or more user output devices 1320. The processing system 1304 also generally includes data storage 1324. In addition, a communication interface 1328 can be provided, to support interconnection of the processing system 1304 to the hyperspectral image sensor 100. Interconnection of the processing system 1304 to external systems or networks can be provided by the same communication interface 1328 used to connect the processing system 1304 to the hyperspectral image sensor 100, or by additional communication interfaces.

The processor 1308 can include a general purpose programmable processor or any other processor capable of performing or executing instructions encoded in software or firmware. In accordance with embodiments of the present disclosure, the processor 1308 may comprise a controller, field programmable gate array, application specific integrated circuit, or other device capable of performing instructions. The memory 1312 may be used to store programs and/or data, for example in connection with the execution of code or instructions by the processor 1308. As examples, the memory 1312 may comprise random-access memory, dynamic random access memory, synchronous dynamic random access memory, or other solid-state memory. A user input device 1316 that allows a user to input commands, including commands that control training or operation of application programming and operation of the imaging system 500 can be included as part of the processing system 1304. Examples of user input devices 1316 that can be provided include a keyboard, keypad, microphone, biometric input device, touch screen, joystick, mouse, or other position encoding device, or the like. A user output device 1320 that can be included as part of the processing system 1304 can include, but is not limited to, a display, speaker, printer, or the like. Moreover, a user input device 1316 and a user output device 1320 can be integrated, for example through a graphical user interface with a pointing device controlled cursor or a touchscreen display. Like the memory 1312, the data storage 1324 may comprise a solid-state device. Alternatively or in addition, the data storage 1324 may comprise, but is not limited to, a hard disk drive, a tape drive, or other addressable storage device or set of devices. Moreover, the data storage 1324 can be provided as an integral component of the processing system 1304, or as an interconnected data storage device or system.

The data storage 1324 may provide storage for a system application 1332 that operates to assign a spectral band to light incident on hyperspectral pixels 104 included in an associated imaging system 500. The system application 1332 can additionally determine the intensity of light incident on the hyperspectral pixels 104. In accordance with at least some embodiments of the present disclosure, the system application 1332 includes or implements a neural network that assigns a spectral band to light incident on the hyperspectral pixels 104 of the imaging system 500 using the outputs of the sub-pixels 604 included in each of the hyperspectral pixels 104 and by applying training data. In accordance with embodiments of the present disclosure, the number spectral bands to which incident light can be assigned by a neural network implemented by the system application 1332 for the hyperspectral pixels 104 is greater than the number of sub-pixels 604 included in those hyperspectral pixels 104. In accordance with other embodiments of the present disclosure, the system application 1332 can refer to empirically derived information regarding the relative response of sub-pixels 604 within a hyperspectral pixel 104 in order to assign a spectral band to light incident on the hyperspectral pixel 104, again with the possibility of assigning the incident light 108 to one of a number of spectral bands that is in excess of the number of sub-pixels 604 within the hyperspectral pixel 104. In accordance with embodiments of the present disclosure, the system application 1332 can operate to output an image representing or reconstructing the determined spectral resolution and/or intensity at each of the hyperspectral pixels 104 included in the imaging system 500. Alternatively or in addition, the system application 1332 can provide a numerical representation of the assigned spectral values and intensities. The system application 1332 can additionally operate to provide a graphical user interface to a user through the user input device 1316 and the user output device 1320.

The data storage 1324 may also provide storage for system data 1336. The system data 1336 can include information regarding the relative response of sub-pixels 604 included in the least some of the hyperspectral pixels 104. More particularly, in accordance with the least some embodiments of the present disclosure, the system data 1336 can include information regarding the response of sub-pixels 604 for at least some hyperspectral pixels 104 within the hyperspectral image system 100 included in the imaging system 500 when illuminated by incident light at a number of different, known wavelengths. As discussed in greater detail elsewhere herein, the information regarding the response of sub-pixels 604 can be used to train a neural network or deep neural network to assign a spectral band to incident light having an unknown wavelength.

Operating system software or instructions 1340 can also be stored in the data storage 1324. As can be appreciated by one of skill in the art after consideration of the present disclosure, the operating system software 1340 can manage the software, applications, and hardware included in or associated with the processing system 1304.

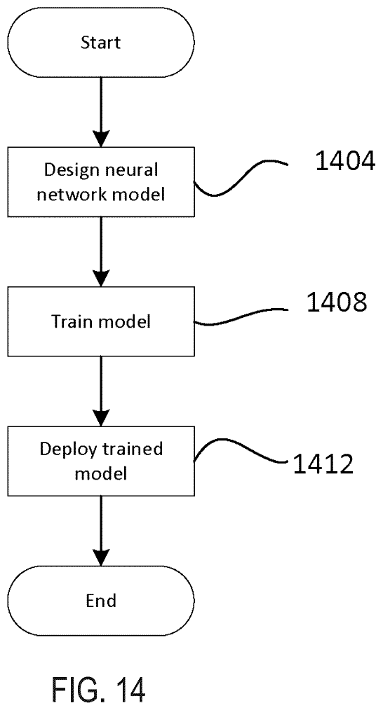

With reference now to FIG. 14, aspects of a method for training a neural network implemented by a system application 1332 included in or associated with an imaging system 500 incorporating a hyperspectral imaging system 100 having hyperspectral pixels 104 in accordance with embodiments of the present disclosure are presented. Initially, a neural network or deep neural network model is designed (step 1404). Designing the neural network model can include establishing an input layer, an output or target layer, and a number of hidden layers. The neural network model is then trained by providing pairs of output signals from the sub-pixels 604 of a hyperspectral pixel 104 for each of a selected number of spectral bands (step 1408). For example, where a desired range of spectral sensitivity extends from wavelengths of 400 nm to 980 nm, with a desired spectral resolution of 20 nm, the system needs to be trained to assign incident light of an unknown wavelength to one of thirty spectral bands having a spectral width of 20 nm. As a result, the hyperspectral pixel 504 is sequentially illuminated with light at one of 30 different wavelengths, with one wavelength falling into each of the spectral bands. For instance, where a hyperspectral pixel 504 includes 9 sub-pixels 604, the output from each of the sub-pixels 604 in response to each of the 30 different wavelengths is used to train the neural network model. More generally stated, where M is the number of sub-pixels 604 within a hyperspectral pixel 504, and X is the number of spectral bands to be recognized, the neural network model is trained by providing pairs of X and M vectors. Accordingly, embodiments of the present disclosure can be trained to assign incident light 508 to any number of wavelength ranges. Moreover, the number of wavelength ranges to which a trained image sensor 100 in accordance with embodiments of the present disclosure can assign to light incident on a hyperspectral pixel 504 can be greater than the number of sub-pixels 604 in that hyperspectral pixel 504. As a result of this process, a trained neural network model is obtained (step 1412). The training process can then end.

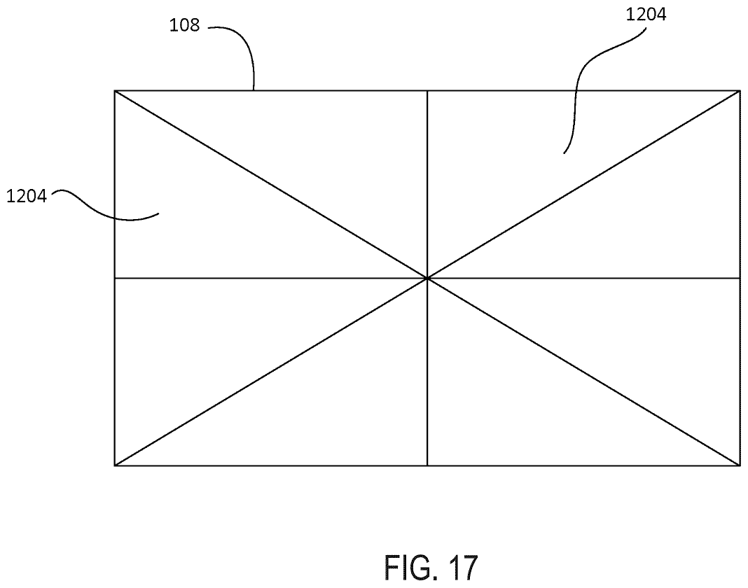

In accordance with embodiments of the present disclosure, the neural network model can be trained to recognize the response of each hyperspectral pixel 104 within an image sensor 100 of an imaging system 500 to light of different wavelengths. In accordance with still other embodiments of the present disclosure, and in particular where sets of diffraction elements 524 are repeated across areas of the image sensor 100 at which hyperspectral pixels 104 operate with the same or a similar set of possible angles of arrival for incident light, training data for one such hyperspectral pixel 104 can be applied to all such hyperspectral pixels 104 within the image sensor 100. For instance, by arranging patterns of diffraction elements 528 such that the same pattern is used across a set of hyperspectral pixels 104 having the same or similar angular relationship to incident light as one another, training can be performed with respect to sections of the image sensor 100. As a particular example, the training can be performed for the hyperspectral pixels 504 within a single segment 1704 of the full array 108 of hyperspectral pixels 104, and that training can then be applied to hyperspectral pixels 504 within all of the segments 1704 of the array 108 (see FIG. 17).

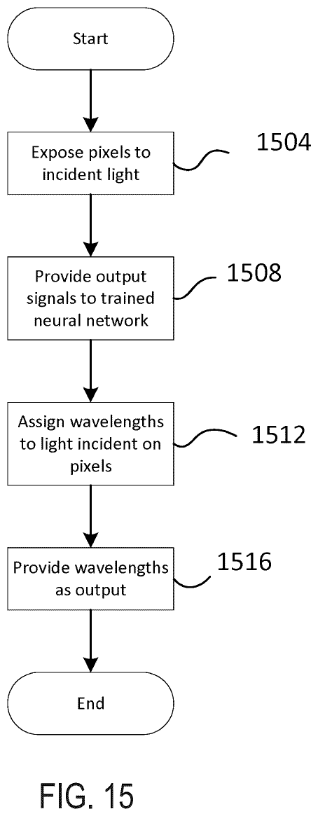

With reference now to FIG. 15, aspects of a method for reconstructing an image received at the hyperspectral pixels 104 of an imaging system 500 in accordance with embodiments of the present disclosure are depicted. Initially, the hyperspectral pixels 104 of the imaging system 500 are exposed to incident light (step 1504). As can be appreciated by one of skill in the art after consideration of the present disclosure, by exposing the hyperspectral pixels 104 to incident light 508, the sub-pixels 604 included in each of the hyperspectral pixels 104 can produce an output signal. Moreover, as discussed herein, the diffraction elements 528 associated with the hyperspectral pixels 104 produce diffracted light 532 having a pattern that is a dependent on and unique to the wavelength of the incident light 508. The output signals from the sub-pixels 604 within the hyperspectral pixels 104 are then provided to the trained neural network model (step 1508). The neural network model then operates to recover the unknown spectrum of the light incident on the hyperspectral pixels 504 by using the different relative intensities of light incident on the sub-pixels 604 to recognize and assign a wavelength or wavelength range to the light incident on each of the hyperspectral pixels 104 of the imaging system 500 (step 1512). In accordance with embodiments of the present disclosure, the recovery or reconstruction of the wavelength of light incident on the hyperspectral pixels 104 of the image sensor 100 can include assigning the light incident on individual hyperspectral pixels 104 to one of a plurality of spectral bands or wavelength ranges. Moreover, the number of possible spectral bands to which the light incident on any one hyperspectral pixel 104 is assigned can be greater than the number of sub-pixels 604 included in that hyperspectral pixel 104. Rather, the number of wavelength ranges to which light incident on a pixel 104 is assigned depends on the number of wavelength ranges that the model implemented by the neural network has been trained to recognize. Moreover, the number of wavelength ranges and the resolution with which individual wavelengths can be assigned depends on the training of the neural network, not on the number of sub-pixels 604 of the hyperspectral pixels 104. Accordingly, embodiments of the present disclosure are capable of recognizing a wavelength of incident light within a spectral resolution that is greater than the resolution available using analytical methods.

The recovered wavelength information for each of the hyperspectral pixels 104 within the image sensor 100 can then be provided as an output (step 1516). The output can include a numerical indication of the spectral band to which the light within a particular hyperspectral pixel 104 has been assigned. For instance, a wavelength equal to a middle value of the assigned spectral band can be provided. In addition, an indication of the intensity of the light incident on the particular hyperspectral pixel 104 can be provided as a numeric value. In accordance with still other embodiments of the present disclosure, output can be provided as an image, in addition or as an alternative to providing numeric values. Where the reconstructed image information is output as an image, assigned wavelengths that fall outside of the visible range can be depicted by pseudo color or wavelength information. The process of reconstructing signals received at the hyperspectral pixels 104 of the imaging system 500 can then end.

In accordance with other embodiments of the present disclosure, sample information regarding the response of sub-pixels 604 within the hyperspectral pixels 104 of an image sensor 100 can be tabulated. The tabulated information can then be compared to the response of the sub-pixels 604 of the hyperspectral pixels 104 in response to elimination by light having an unknown wavelength composition. The wavelength of the incident light can then be reconstructed through a comparison of the response of the sub-pixels 604 within the hyperspectral girl pixels 504 to the light having an unknown wavelength composition, to the tabulated information. In accordance with embodiments of the present disclosure, the number of spectral bands for which the response of the sub-pixels 604 of the hyperspectral pixels 104 are tabulated is greater than the number of sub-pixels 604 in each of the hyperspectral pixels 104. Accordingly, the number of spectral bands into which light incident on a particular hyperspectral pixel 104 can be assigned is greater than the number of sub-pixels 604 in the hyperspectral pixel 104.

Accordingly, embodiments of the present disclosure enable the color of light incident on a hyperspectral pixel 104 to be determined without requiring the use of color filters. Therefore, the sensitivity of the color image sensor 100 can be greater than conventional color sensing devices. In addition, the stack height of the hyperspectral pixel 104 structures disclosed herein are relatively low. Moreover, embodiments of the present disclosure enable a color image sensor 100 to be created using only CMOS processes. In addition, embodiments of the present disclosure allow greater spectral resolution for a given image resolution than devices and methods incorporating analytical determinations of the wavelength of incident light.

In accordance with other embodiments of the present disclosure, at least some of the sets of diffraction features 524 can be shifted according to a location of an associated hyperspectral pixel 104 within the array 108, such that a center point of the pattern coincides with a chief ray angle of incident light at that hyperspectral pixel 104. In accordance with still other embodiments, different patterns or configurations of diffraction elements 528 can be associated with different hyperspectral pixels 104 within an image sensor 100. For example, each hyperspectral pixel 104 can be associated with a different pattern of diffraction features 528. As another example, a particular diffraction element 528 pattern can be used for all of the hyperspectral pixels 104 within all or selected regions of the array 108. As a further example, differences in diffraction feature or element 528 patterns can be distributed about the hyperspectral pixels 104 of an image sensor randomly. Alternatively or in addition, different diffraction element 528 patterns can be selected so as to provide different focusing or diffraction characteristics at different locations within the array 108 of hyperspectral pixels 104. For instance, aspects of a diffraction element 528 pattern can be altered based on a distance of a pixel associated with the pattern from a center of the array 108.

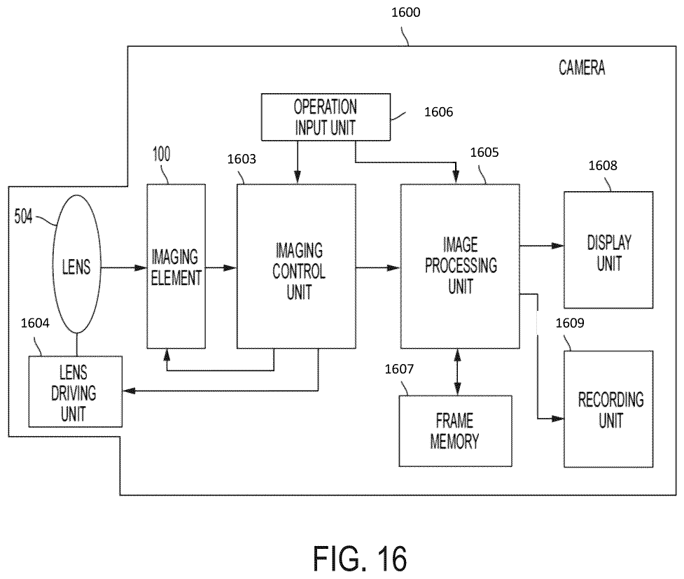

FIG. 16 is a block diagram illustrating a possible configuration of a camera 1600 that is an example of an imaging apparatus to which a system 500, and in particular an image sensor 100 having hyperspectral pixels 504 in accordance with embodiments of the present disclosure can be applied. As depicted in the figure, the camera 1600 includes an optical system or lens 504, an image sensor 100, an imaging control unit 1603, a lens driving unit 1604, an image processing unit 1605, an operation input unit 1606, a frame memory 1607, a display unit 1608, and a recording unit 1609.

The optical system 504 includes an objective lens of the camera 1600. The optical system 504 collects light from within a field of view of the camera 1600, which can encompass a scene containing an object. As can be appreciated by one of skill in the art after consideration of the present disclosure, the field of view is determined by various parameters, including a focal length of the lens, the size of the effective area of the image sensor 100, and the distance of the image sensor 100 from the lens. In addition to a lens, the optical system 504 can include other components, such as a variable aperture and a mechanical shutter. The optical system 504 directs the collected light to the image sensor 100 to form an image of the object on a light incident surface of the image sensor 100.

As discussed elsewhere herein, the image sensor 100 includes a plurality of hyperspectral pixels 104 disposed in an array 108. Moreover, the image sensor 100 can include a semiconductor element or substrate 112 in which the hyperspectral pixels 104 each include a number of sub-pixels 604 that are formed as photosensitive areas or photodiodes within the substrate 112. In addition, as also described elsewhere herein, each hyperspectral pixel 104 is associated with a set of diffraction features 528 formed in a diffraction element layer 520 positioned between the optical system 504 and the sub-pixels 604. The photosensitive sites or sub-pixels 604 generate analog signals that are proportional to an amount of light incident thereon. These analog signals can be converted into digital signals in a circuit, such as a column signal processing circuit 120, included as part of the image sensor 100, or in a separate circuit or processor. As discussed herein the distribution of light amongst the sub-pixels 604 of a hyperspectral pixel 104 is dependent on the wavelength of the incident light. The digital signals can then be output.

The imaging control unit 1603 controls imaging operations of the image sensor 100 by generating and outputting control signals to the image sensor 100. Further, the imaging control unit 1603 can perform autofocus in the camera 1600 on the basis of image signals output from the image sensor 100. Here, “autofocus” is a system that detects the focus position of the optical system 504 and automatically adjusts the focus position. For example, a method in which an image plane phase difference is detected by phase difference pixels arranged in the image sensor 100 to detect a focus position (image plane phase difference autofocus) can be used. Further, a method in which a position at which the contrast of an image is highest is detected as a focus position (contrast autofocus) can also be applied. The imaging control unit 1603 adjusts the position of the lens 1001 through the lens driving unit 1604 on the basis of the detected focus position, to thereby perform autofocus. Note that the imaging control unit 1603 can include, for example, a DSP (Digital Signal Processor) equipped with firmware.

The lens driving unit 1604 drives the optical system 504 on the basis of control of the imaging control unit 1603. The lens driving unit 1604 can drive the optical system 504 by changing the position of included lens elements using a built-in motor.

The image processing unit 1605 processes image signals generated by the image sensor 100. This processing includes, for example, assigning a light state to light incident on a hyperspectral pixel 104 by determining ratios of signal strength between pairs of sub-pixels 604 included in the hyperspectral pixel 104, and determining an amplitude of the hyperspectral pixel 104 signal from the individual sub-pixel 604 signal intensities, as discussed elsewhere herein. In addition, this processing includes determining a wavelength of light incident on a hyperspectral pixel 104 by implementing a trained neural network. The image processing unit 1605 can include, for example, a microcomputer equipped with firmware, and/or a processor that executes application programming, to implement processes for identifying color information in collected image information as described herein.

The operation input unit 1606 receives operation inputs from a user of the camera 1600. As the operation input unit 1606, for example, a push button or a touch panel can be used. An operation input received by the operation input unit 1606 is transmitted to the imaging control unit 1603 and the image processing unit 1605. After that, processing corresponding to the operation input, for example, the collection and processing of imaging an object or the like, is started.

The frame memory 1607 is a memory configured to store frames that are image signals for one screen or frame of image data. The frame memory 1607 is controlled by the image processing unit 1605 and holds frames in the course of image processing.

The display unit 1608 can display information processed by the image processing unit 1605. For example, a liquid crystal panel can be used as the display unit 1608.

The recording unit 1609 records image data processed by the image processing unit 1605. As the recording unit 1609, for example, a memory card or a hard disk can be used.

An example of a camera 1600 to which embodiments of the present disclosure can be applied has been described above. The image sensor 100 of the camera 1600 can be configured as described herein. Specifically, the image sensor 100 can diffract incident light across different light sensitive areas or sub-pixels 604 of a hyperspectral pixel 104, and can assign incident light of an unknown wavelength to one of a plurality of wavelength bands.

FIG. 17 depicts a light incident surface side of an array 108 of hyperspectral pixels 104 in accordance with embodiments of the present disclosure, divided into eight segments or areas 1704 disposed symmetrically about a center point 1708 of the array 108. In accordance with embodiments of the present disclosure, patterns of diffraction elements 528 can be repeated such that, for a given angle of incidence of light collected by the imaging optics 504 and passed to the array 108, the diffractive patterns they produce are the same. In addition, and as discussed in greater detail elsewhere herein, the response of the sub-pixels 604 within the hyperspectral pixels 104 to incident light at different wavelengths can be characterized within any one of the eight segments 1704. Accordingly, and as discussed in greater detail elsewhere herein, the creation and the operation of a system, such as but not limited to a neural network, capable of determining a spectrum of light incident on a hyperspectral pixel 104 within a hyperspectral image sensor 100 in accordance with embodiments of the present disclosure can be completed efficiently.

Note that, although a camera has been described as an example of an electronic apparatus, an image sensor 100 and other components, such as processors and memory for executing programming or instructions and for storing calibration information as described herein, can be incorporated into other types of devices. Such devices include, but are not limited to, surveillance systems, automotive sensors, scientific instruments, medical instruments, etc. In accordance with still other embodiments, a system 100 as disclosed herein be implemented in connection with a communication system, in which information is encoded or is distinguished from other units of information using the color and polarization state of light. Still other applications of embodiments of the present disclosure include quantum computing.

As can be appreciated by one of skill in the art after consideration of the present disclosure, an image sensor 100 as disclosed herein utilizes interference effects to obtain color information. In addition, an image sensor 100 as disclosed herein can be produced using CMOS processes entirely. Implementations of an image sensor 100 or devices incorporating an image sensor 100 as disclosed herein can utilize a neural network trained for the hyperspectral pixels 104 of the image sensor 100.

Methods for producing an image sensor 100 in accordance with embodiments of the present disclosure include applying conventional CMOS production processes to produce an array of hyperspectral pixels 104 in an image sensor substrate 112 in which each hyperspectral pixel 104 includes a plurality of sub-pixels or photodiodes 604. As an example, the material of the sensor substrate 112 is silicon (Si), and each sub-pixel 604 is a photodiode formed therein. A diffraction layer 520 containing sets of diffraction elements 528 can be disposed on or adjacent to a light incident side of the image sensor substrate 112. Moreover, the diffraction layer 520 can be disposed on a back surface side of the image sensor substrate 112. As an example, the diffraction layer 520 is silicon oxide (SiO₂), and has a thickness of 400 nm or less. In accordance with the least some embodiments of the present disclosure, an anti-reflection layer can be disposed between the light incident surface of the image sensor substrate 112 and the diffraction layer 520. A set of diffraction features 528 is provided for each of the hyperspectral pixels 104. The set of diffraction features 528 can be formed as transparent features disposed in one or more layers configured as trenches formed in the diffraction layer 520 and/or as trenches formed in the sensor substrate 112. For example, the diffraction elements 528 in the diffraction layer 520 can be formed from TiO2, and diffraction elements 528 in the sensor substrate 112 can be formed from SiO2. The diffraction elements 528 can be relatively thin (i.e. from about 100 to about 200 nm), and the pattern can include a plurality of diffraction elements 528 of various sizes. Production of an image sensor 100 in accordance with embodiments of the present disclosure can be accomplished using only CMOS processes. Moreover, an image sensor produced in accordance with embodiments of the present disclosure does not require micro lenses or wavelength selective filters for each pixel.

The foregoing has been presented for purposes of illustration and description. Further, the description is not intended to limit the disclosed systems and methods to the forms disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosed systems and methods, and to enable others skilled in the art to utilize the disclosed systems and methods in such or in other embodiments and with various modifications required by the particular application or use. It is intended that the appended claims be construed to include alternative embodiments to the extent permitted by the prior art.

What is claimed is:

1. A method, comprising:
collecting light from a scene;
passing the collected light through a first set of diffraction elements, wherein first diffracted light is produced, wherein the first diffracted light is incident on M sub-pixels of a first pixel of an image sensor, and wherein an output signal is produced by each of the M sub-pixels of the first pixel; and
processing the output signals from the M sub-pixels of the first pixel to determine one of X spectral bands a wavelength of the first diffracted light incident on the M sub-pixels of the first pixel belongs, wherein X is greater than M.

2. The method of claim 1, wherein the pixel includes M sub-pixels.

3. The method of claim 1, further comprising:
providing an output, wherein the output includes an indication of a wavelength of the first diffracted light.

4. The method of claim 3, wherein the indication of a wavelength of the first diffracted light is an identification of a first one of the X spectral bands

5. The method of claim 3, wherein the output further includes an indication of an intensity of the first diffracted light.

6. The method of claim 1, wherein processing the M output signals from the M sub-pixels of the first pixel to determine which of X spectral bands a wavelength of the first diffracted light belongs includes providing the M outputs of the M sub-pixels of the first pixel to a neural network.

7. The method of claim 6, further comprising:
providing an output from the neural network, wherein the output from the neural network includes an indication of a wavelength of the first diffracted light.

8. The method of claim 6, wherein the neural network is trained to assign the light incident on the sub-pixels of the first pixel to one of the X spectral bands.

9. The method of claim 8, wherein training the neural network includes passing light of a plurality of known wavelengths through the first set of diffraction elements and determining a response of the M sub-pixels of the first pixel to each of the different known wavelengths.

10. The method of claim 1, further comprising:
passing the collected light through a second set of diffraction elements, wherein second diffracted light is produced, wherein the second diffracted light is incident on M sub-pixels of a second pixel of the image sensor, and wherein an output signal is produced by each of the M sub-pixels of the second pixel; and
processing the output signals from the M sub-pixels of the second pixel to determine one of the X spectral bands a wavelength of the second diffracted light incident on the M sub-pixels of the second pixel belongs.

11. The method of claim 10, wherein processing the M output signals from the M sub-pixels of the first pixel to determine which of X spectral bands a wavelength of the first diffracted light belongs includes providing the M outputs of the M sub-pixels of the first pixel to a neural network, and wherein processing the M output signals from the M sub-pixels of the second pixel to determine which of X spectral bands a wavelength of the second diffracted light belongs includes providing the M outputs of the M sub-pixels of the second pixel to the neural network.

12. The method of claim 11, wherein the neural network is trained to assign the light incident on the sub-pixels of the first pixel to one of the X spectral bands, and wherein the neural network is trained to assign the light incident on the sub-pixels of the second pixel to one of the X spectral bands.

13. The method of claim 12, wherein training the neural network includes passing light of a plurality of known wavelengths through the first set of diffraction elements and determining a response of the M sub-pixels of the first pixel to each of the different known wavelengths, and wherein training the neural network further includes passing light of the plurality of known wavelengths through the second set of diffraction elements and determining a response of the M sub-pixels of the second pixel to each of the different known wavelengths.

14. The method of claim 12, wherein the first and second sets of diffraction elements are the same, and wherein training the neural network includes passing light of a plurality of known wavelengths through one of the first and second sets of diffraction elements and determining a response of the M sub-pixels of the one of the first and second pixels to each of the different known wavelengths.

15. The method of claim 14, wherein an angle of incidence of the light collected from the scene on the first pixel is equal to an angle of incidence of the light collected from the scene on the second pixel.

16. The method of claim 1, wherein the X spectral bands includes at least one band encompassing visible wavelengths and at least one band encompassing infrared wavelengths, wherein X is equal to or greater than 25, and wherein M is equal to or less than 9.

17. An image sensor, comprising:
a plurality of pixels disposed in an array, wherein each pixel in the plurality of pixels includes M sub-pixels formed in a substrate;
a plurality of sets of diffraction elements, wherein one set of diffraction elements is disposed on a light incident surface side of each pixel in the plurality of pixels;
a processor, wherein outputs of the M sub-pixels of the plurality of pixels in response to the M sub-pixels receiving light diffracted by the diffraction elements are provided to the processor, wherein the processor executes application programming that provides an output that includes a determination of which one of X spectral bands that light incident on the sub-pixels of a first pixel in the plurality of pixels belongs and that further provides an output that includes a determination of which of the X spectral bands that light incident on the sub-pixels of a second pixel in the plurality of pixels belongs, and wherein X is greater than M.

18. The image sensor of claim 17, wherein the application programming executed by the processor to provide the outputs implements a neural network.

19. The image sensor of claim 18, wherein the sets of diffraction elements have an index of refraction that is different than an index of refraction of the substrate.

20. A sensor system, comprising:
an imaging lens:
an image sensor, the image sensor including:
a plurality of pixels disposed in an array, wherein each pixel in the plurality of pixels includes M sub-pixels formed in a substrate;
a plurality of sets of diffraction elements, wherein one set of diffraction elements is disposed on a light incident surface side of each pixel in the plurality of pixels;
a processor, wherein outputs of the M sub-pixels of the plurality of pixels in response to the M sub-pixels receiving light diffracted by the diffraction elements are provided to the processor, wherein the processor executes application programming that provides an output that includes a determination of which one of X spectral bands that light incident on the sub-pixels of a first pixel in the plurality of pixels belongs and that further provides an output that includes a determination of which of the X spectral bands that light incident on the sub-pixels of a second pixel in the plurality of pixels belongs, and wherein X is greater than M; and
an output device, wherein the output device provides an indication of which one of the X spectral bands that light incident on the sub-pixels of a first pixel in the plurality of pixels belongs, an indication of an intensity of the light on the sub-pixels of the first pixel, an indication of which one of the X spectral bands that light incident on the sub-pixels of the second pixel in the plurality of pixels belongs, and an indication of an intensity of the light on the sub-pixels of the second pixel.
